(19) United States
(12) Patent Application Publication
(10) Pub. No.: US 2006/0242017 A1
(43) Pub. Date: Oct. 26, 2006

(54) Method and system of bidding for advertisement placement on computing devices

(75) Inventors: Michael Libes, Bainbridge Island, WA (US); Brian Lent, Bellevue, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Medio Systems, Inc., Seattle, WA (US)

(21) Appl. No.: 11/372,904

(22) Filed: Mar. 9, 2006

Related U.S. Application Data
(60) Provisional application No. 60/660,489, filed on Mar. 9, 2005.
(60) Provisional application No. 60/749,720, filed on Dec. 12, 2005.

(51) Int. Cl. G06Q 30/00

(52) U.S. Cl. 705/14

(57) ABSTRACT

A computer system and method for processing a search query directed to a collection of pages includes receiving a search query of a user, identifying one or more result pages from the collection of pages in response to the search query, comparing keywords of the search query and a concept hierarchy of the result pages and user features against a set of bids for keywords, concepts, and user features that are submitted by advertisers to identify matching bids. A winning bid is selected from among the matching bids. The winning bid corresponds to an advertiser who may specify a sponsored link or sponsored page that is offered to the user in response to the search query.

### CROSS-REFERENCE TO RELATED APPLICATIONS

This application claims the benefit of U.S. Provisional Application No. 60/660,489 filed Mar. 9, 2005 entitled Search Application for Mobile Content and claims the benefit of U.S. Provisional Application No. 60/749,720 filed Dec. 12, 2005 entitled Mobile Device Advertising Platform. The disclosures of 60/660,489 and 60/749,720 are incorporated herein by reference in their entirety.

### BACKGROUND

The present invention relates to advertising placement systems for use with computing devices and, more particularly, to systems that support competitive bidding for placement of advertising to computing devices.

Computing networks are commonly used in everyday life. The most ubiquitous example of a common computing network is probably the Internet. Millions of users get online to the Internet and retrieve information over the Internet daily, through the user of Internet browser applications that are able to “visit” Internet sites (collectively referred to as the World Wide Web). Most users access the World Wide Web through desktop or laptop computing devices through either wired or wireless network connections. A similar network is available to users with mobile platforms, such as Personal Digital Assistants (PDAs) and Web-enabled mobile telephones, who generally gain access to the Internet through a wireless connection.

One common network activity is to search for Internet sites that have content of interest. Internet sites are collections of content called “pages” that can be reviewed with appropriate browsers. Search queries can be submitted and pages that are relevant to the search query terms can be returned to a user's browser for viewing. It is now common for search results to be returned with sponsored results. That is, advertising content, paid for by advertiser sponsors, is returned along with search results. The sponsors typically pay a fee, or enter a bid, so that user search queries that include particular keywords that have been paid for by a sponsoring advertiser will return links to pages specified by that sponsoring advertiser. Such links are commonly referred to as sponsored links. Such online advertising is increasing in popularity with advertisers.

Search queries are typically comprised of one or more words. The words in the query are compared against an index of page information to identify relevant pages, links to which are returned as search results. Each of the words in the query is referred to as a keyword. The collection of keywords determines the set of sponsored links, as well as the search result links.

Online advertising is commonly based around the keyword. This is especially true for search-based advertising, where the searcher has explicitly entered keywords which can be matched to an inventory of keyword-targeted advertisements. This is also true for general Web pages, where the keywords are extracted from the text on the page or from meta-data provided within the page.

Using keyword targets is not ideal. Not all advertisers want to bid on hundreds, thousands, or millions of keywords. Moreover, a keyword is not the only item that can be bid upon by advertisers when considering mobile search. Many advertisers would prefer a simpler means of targeting a highly focused audience using simpler means, including in the context of mobile search. From the discussion above, it should be apparent that there is a need for a more closely targeted advertising scheme, particularly for mobile search, that is directed to an audience of interest. The present invention satisfies this need.

### SUMMARY

Embodiments of the invention pertain to a computer system and method for processing a search query directed to a collection of pages in response to receiving a search query of a user, by identifying one or more result pages from the collection of pages in response to the search query, comparing keywords of the search query and a concept hierarchy of the result pages and user features against a set of bids for keywords, concepts, and user features submitted by advertisers to identify matching bids, and selecting a winning bid from among the matching bids. The winning bid corresponds to an advertiser who has placed the highest bid that matches a user search query across the multiple criteria, including keywords, concepts, and user features. The winning advertiser may specify a sponsored link or sponsored page that will be offered to the user in response to the matched search query. Thus, rather than bidding on a vast number of possible keywords, advertisers can use a simpler solution of bidding for their own selected combination of keywords, page concepts, and user features for targeting a highly focused audience. The user features can include user profile information and user physical location and proximity. By submitting bids, the advertisers can specify the combination of keywords, page concepts, and user features as being of most importance to them. In this way, only combinations of keywords, concepts, and user features that meet the specifications of the advertiser will satisfy the search query, resulting in an action desired by the advertiser, such as the display of a selected page and rendering on a mobile device. In this way, advertisers can obtain a more closely targeted advertising scheme that is directed to an audience of interest.

In one aspect of a scheme in accordance with the invention, the concept hierarchy specifies a predetermined categorization of pages that might be returned as search results. For example, a concept hierarchy, moving from more general concept to more specific concept, might comprise the concepts of sports, baseball, U.S. Major League baseball, New York Yankees. In another aspect, the user features can comprise user self-identified group orientations, such as male/female, age group, group affiliations, and other parameters that could be self-reported by individuals, and also automatically determined characteristics, such as geographic location for location-aware device platforms, user network address, user propensity to purchase specific categories of content, and the like. The user features can include user profiles, which can be indicated by users (self-reporting) or can be determined by data mining and analytic techniques for automatic detection and attribution. User profiles might comprise, for example, an arbitrary grouping of user characteristics, age groups, residence location, group affiliations and memberships, usage statistics, and the like.

Other features and advantages of the present invention should be apparent from the following description of the preferred embodiments, which illustrate, by way of example, the principles of the invention.

### BRIEF DESCRIPTION OF THE DRAWINGS

FIG. 1 is a block diagram of a system that supports bidding for advertisement placement on computing devices in accordance with the invention.

FIG. 2 depicts details for two of the advertisers shown in FIG. 1.

FIG. 3 shows exemplary details for one of the mobile-specific advertisements of FIG. 2.

FIG. 4 depicts a set of pages that are clustered into various concepts for search by the FIG. 1 system.

FIG. 5 is a user interface screenshot that shows setting distances for the location criterion for ad placement bidding in the advertising system of FIG. 1.

FIG. 6 shows an example of a profile database entry for a single user of the system of FIG. 1.

FIG. 7 is a screen shot depicting a GUI and sequence of events according to one exemplary implementation of the invention.

FIG. 8 shows a user interface screenshot of the display window for entering an advertisement bid and targeting the bid in the system of FIG. 1.

FIG. 9 is a block diagram of exemplary software architecture for the system illustrated in FIG. 1.

FIG. 10 illustrates an exemplary arrangement of components for a system constructed in accordance with the invention.

FIG. 11 is a user interface screenshot that shows selection of particular concepts for the “concept” targeting criterion for ad placement bidding in the advertising system of FIG. 1.

### DETAILED DESCRIPTION

In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form without unnecessary details that are known to those skilled in the art so as to avoid unnecessary details that could obscure understanding of the present invention.

These and other embodiments of the invention along with many of its advantages and features are described in more detail in conjunction with the text below and attached figures.

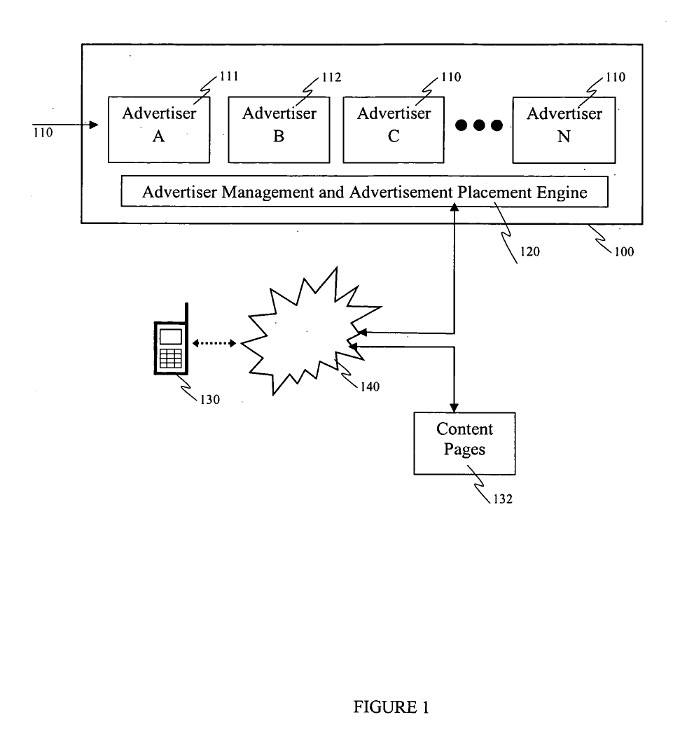

FIG. 1 is a block diagram that depicts a system 100 that supports bidding for advertisement placement on computing devices according to an embodiment of the invention. In the system 100, user search requests from computing devices 130 are directed to collections of content and pages 132 that are available to the computing devices over the network 140. In accordance with the invention, advertisements are targeted to users of the devices 130 based on a combination of keywords in search queries, concepts presented on pages identified in the search query processing, and user features. Thus, rather than target advertising by looking only to the keywords provided by users to search for pages, the system 100 also considers concepts presented on the pages themselves, as well as characteristics of the users seeking pages through search queries.

The computing devices 130 can comprise fixed platforms such as desktop computers and laptop computers and can comprise mobile platforms such as mobile telephones and PDAs and handsets, all of which communicate with the advertising placement system 100 over a network 140 such as the Internet. The communication can take place via wired or wireless connection to the network 140. In the FIG. 1 embodiment, the computing devices 130 and the network 140 are illustrated as communicating via wireless connections, but it should be understood that the teachings of the present invention also have applicability to fixed device networks and to networks that are combinations of fixed (wired) and wireless devices. The system can comprise, for example, a server computer with a network interface that permits communication with the network 140. The advertising system 100 includes data relating to a collection of advertisers, each with one or more advertisements to be placed. FIG. 1 shows that the system 100 includes advertisers 110, 111, and 112 that submit bids for placement of advertising, as described further below. The advertisers provide advertising content in accordance with their preferences, such as from their own respective advertising servers or other content sources 132. An Advertiser Management and Advertisement Placement server 120 manages the bids received from the advertisers and places the advertisements to the computing devices 130.

The users of the computing devices 130 typically access pages over the network 140 by means of a browser application that executes on the device. For example, a device 130 comprising a desktop computer or a mobile (laptop) computer might utilize an installed browser application such as “Internet Explorer” or “Firefox”, and a device 130 comprising a cell telephone might use a microbrowser application that executes on the phone itself or an application designed for another purpose that additionally has the ability to display advertisements. For simplicity of description, all these types of mobile applications will be referred to as a “browser” in this document. The advertisements returned to user devices 130 can comprise advertising links or pages themselves or other content that are obtained via network available collections of content 132.

The system 100 can receive user search requests that have been entered by the user through the browser application and forwarded by the network access providers of the users, such as from the wireless service carriers through which the users of the devices 130 gain network access. Alternatively, the network access carrier itself can provide the advertisement placement function in response to a user submitting a search query through the browser. In still another embodiment, a search engine service, independent of the network access carrier, can employ the techniques described herein to receive user search requests and process them in accordance with the features of the present invention, and return targeted advertising.

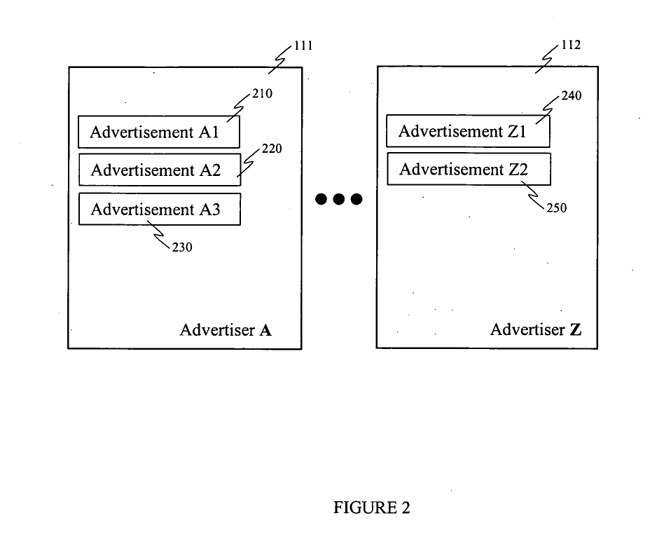

FIG. 2 depicts details for two of the advertisers 111 and 112 shown in FIG. 1. It should be understood that the features described for the two advertisers 111, 112 apply equally to the other advertisers 110 (FIG. 1). In the system 100, each advertiser can provide one or more advertisements or other advertising content to be delivered by the system to users 130. The FIG. 2 detail example illustrates that the first advertiser 111, Advertiser A, has created three advertisements 210, 220, 230 identified respectively as Advertisement A1, Advertisement A2, and Advertisement A3. The second advertiser 112, Advertiser Z, has created two advertisements 240, 250 identified respectively as Advertisement Z1 and Advertisement Z2. These advertisements can comprise Web pages, multimedia material, audio files, graphics images, numeric data such as telephone numbers to call, and the like. The advertising system 100 can support an arbitrary number of advertisers 110, and the system can support an arbitrary number of advertisements for each advertiser.

Advertisement Details

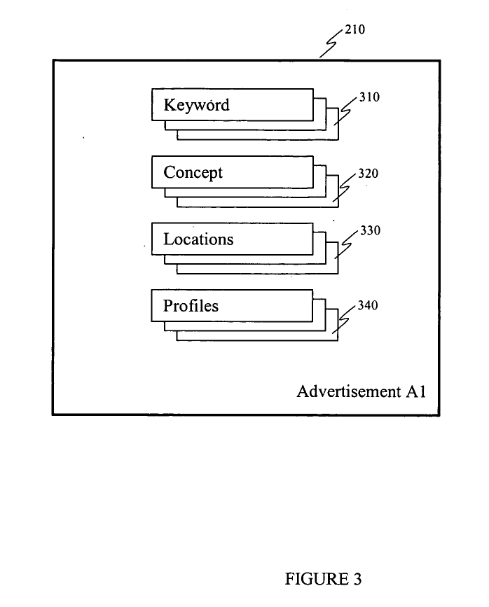

FIG. 3 shows exemplary details for Advertisement A1 210, one of the advertisements of FIG. 2. The advertisement 210 comprises a collection of data that includes multiple targeting criteria. The targeting criteria are used by the Advertising Manager 100 to identify the combination of data that the corresponding advertiser wishes to have considered in matching the advertiser's bid against the search query for comparison with competing bids from other advertisers. All advertisements can use the same set of targeting criteria categories, thus any of the advertisements from FIG. 2 can have these same attributes. As noted above, the conventional category of “keywords” has been somewhat limited in providing advertising placement bidding. In the FIG. 3 example, the targeting criteria categories include data relating to keyword 310 and also concept 320 and user features that, in this example, include physical location 330 and user profile 340. The system 100 (FIG. 1) performs advertisement placement utilizing targeting criteria comprising keyword 310 and at least one other targeting criteria category 320,330,340.

Targeting Criteria Categories

Keyword Criterion

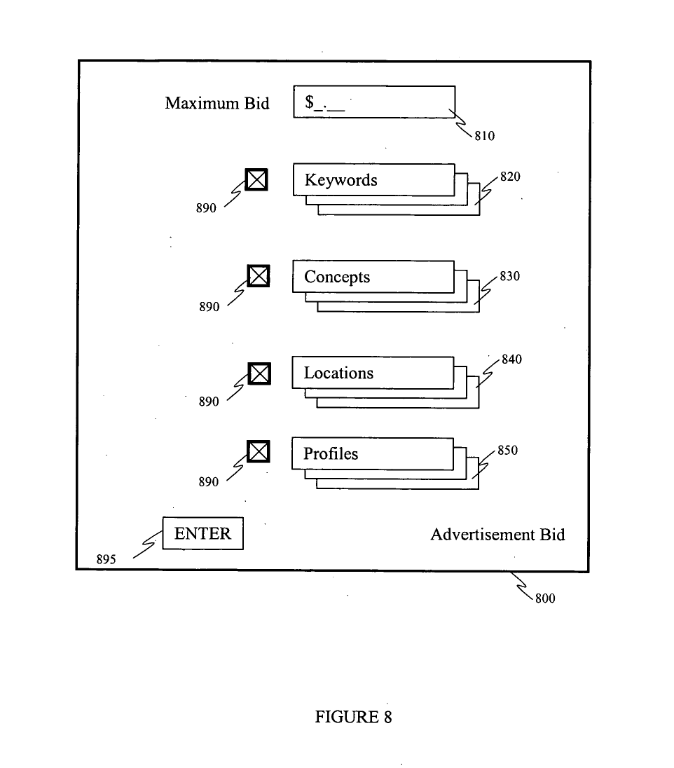

The keyword criterion 310 relates to the conventional search query included in the user search. Bidding for keywords is just one part of the system operation for the advertisement engine 100 described herein. The system 100 supports fixed computing devices as well as mobile devices, thus, mobile advertisements, just as on the Web, can be targeted by keywords 310. An advertisement can contain no keywords, one keyword, or an arbitrary number of keywords. An exemplary bid entry screenshot for advertisers to enter bid amounts is described below in connection with FIG. 8.

Concept Criterion

The “concept” criterion 320 relates to characteristics of pages that are responsive to the user search query. A “concept” as used herein for a targeting criterion refers to a human-generated term denoting a set of pages which have some similarly in their content, purpose, or meaning. An advertisement can contain no concepts, one concept, or an arbitrary number of concepts. The pages, which are Web pages accessible to users who submit search queries, can be organized or grouped according to related concepts, in a hierarchy. The hierarchy can be developed from a set of analytical methods that are invoked to automatically determine these derived concepts. For example, a news story discussing the Yankees professional baseball team and a news story discussing the Dodgers professional baseball team are both related to the “concept” of “baseball”.

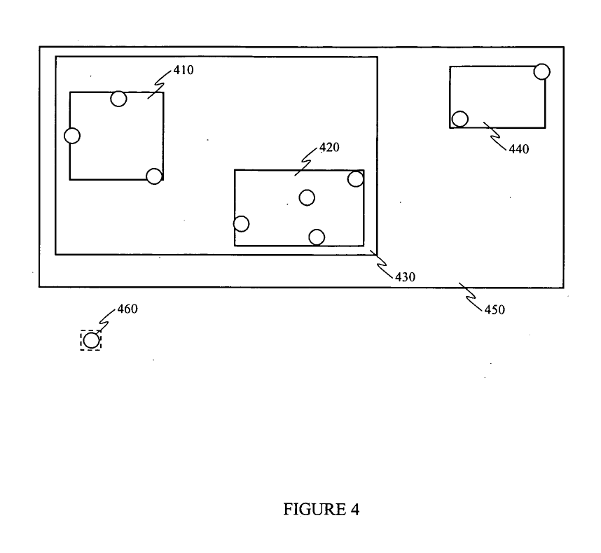

FIG. 4 depicts a set of pages, represented by circular objects, clustered into various concepts. Using the baseball example first described above, one set of pages could all discuss the Yankees and thus fall into the concept 410 of “Yankees”. Another set of pages could all discuss the “Dodgers” and therefore would fall into the concept 420 of “Dodgers”. The collection of both Yankees pages 410 and Dodgers pages 420 would fall under the more general concept 430 of “Major League Baseball”, even if those pages do not specifically contain any of the keywords “major”, “league”, or “baseball”. That is, the Major League Baseball concept 430 is at a higher concept hierarchy than either Yankees 410 or Dodgers 420. Other pages that discuss the concept of Little League Baseball would fall under a different concept 440 of “Little League Baseball”. The collection of pages within concepts 430 and 440 would then fall under the “baseball” concept 450. Other pages 460 that do not discuss baseball at all would fall under an “other” concept 460 or other hierarchies.

Once the concept hierarchy of FIG. 4 is generated, the search query keywords otherwise used to find pages are no longer of great importance for bidding on placement of advertisements. Instead, an advertiser can choose the concept or concepts that best describe the advertiser's target audience. For example, if an advertiser wants to place advertisements on any baseball-related pages, the single concept of “baseball” is the only target criteria required. In a keyword bidding system, it would be necessary for the advertiser to bid on the keyword “baseball”, as well as the name of every baseball team, plus the name of every player on every team, plus every player in the Baseball Hall of Fame, and so forth The resulting complexity of allocating bids and selecting from among them is beyond the ability of many advertisers, resulting in less bidding and poorer targeting of advertisements.

It should be noted that targeting by concepts can include combinations of concepts and other criteria. An exemplary bid entry screenshot for advertisers to enter bid amounts is described further below in connection with FIG. 8. For example, using the bidding interface, an advertiser can bid for a target criteria concept such as “baseball” and then specify that the concept “Yankees” should be excluded from the target criteria. The system described herein can accommodate any such logical collection of inclusion and exclusion for target criteria.

It should also be noted that targeting by concept is not mutually exclusive to targeting by keywords or other criteria. It is possible, for example, to target-an advertisement (that is, bid on ad placement) to the concept of “baseball” when the search keyword “bat” is entered. In this way, an advertiser can enter conditional bidding instructions that the system will execute. This feature is novel and aids in helping an advertiser to discriminate search queries between a baseball bat and the similarly spelled flying animal named “bat”, and to target only the search queries of interest.

For purposes of the advertising engine 100, the manner in which the concept categories are generated is relatively unimportant. The hierarchy of concepts can be generated solely by editorial input, as part of a page indexing process, or the concept hierarchies can be generated using data mining and analytic techniques on the available pages. An exemplary bid entry screenshot for advertisers to enter bid amounts is described below.

User Features Criterion

Another category used by the system 100 for management of advertisement placement is that of user features. The set of characteristics comprising the user features can include self-reported characteristics and automatically determined characteristics. For example, FIG. 3 shows that user features can include user profiles 340 that specify group affiliations and associations, as well as geographic location or network node 330.

User Features—Location

The location criteria 330 relates to location-aware computing platforms, such as those computing devices that are equipped with receivers for the well-known GPS satellites, with which geographic location can be accurately determined. Location can also be determined by well-known wireless network triangulation methods that assist the GPS calculations. Location may also be determined by unique cellular tower identifiers or wireless network access point identifiers broadcast by the wireless network. For example, geographic location through GPS can be determined to within an accuracy of about 3-10 meters, and cellular tower identifiers specify a location within an accuracy of about ten miles. In the present description, “location-aware devices” should be understood to refer to devices that have the capability for such automatic self-determined geographical location. In the United States, Federal mandates for E-911 service make the location targeting criterion especially attractive for use with mobile telephones. Under the E-911 mandate, the majority of mobile telephone handsets are equipped to determine their location within an accuracy measured in tens of meters, as an aid to emergency services crews. This location self-determination has other uses beyond emergency services.

The present system makes use of location-aware devices in targeting advertisements based on location, in accordance with the description herein. Thus, in the present system, mobile advertisements, as on the Web, can be targeted to a user device by distance criteria 330 that relate the user device to a specific geographic location. An advertisement can contain no distance criteria, one distance criteria, or more than one distance criteria. For example, distance criteria can be specified as a user who is “within x feet of y latitude and z longitude.” The y, z geographic coordinates will typically be the location of an advertiser's business, such as a restaurant or local service facility. In this way, the system uses the accuracy of the location data from location-aware computing devices, such as E-911 mobile handsets, to provide more detailed targeting information for advertisements based on the location of the handset. The system uses this capability to support bidding for advertisement placement with user location as a bidding criteria, providing a more attractive system for advertisers and providing more relevant sponsored ads for users.

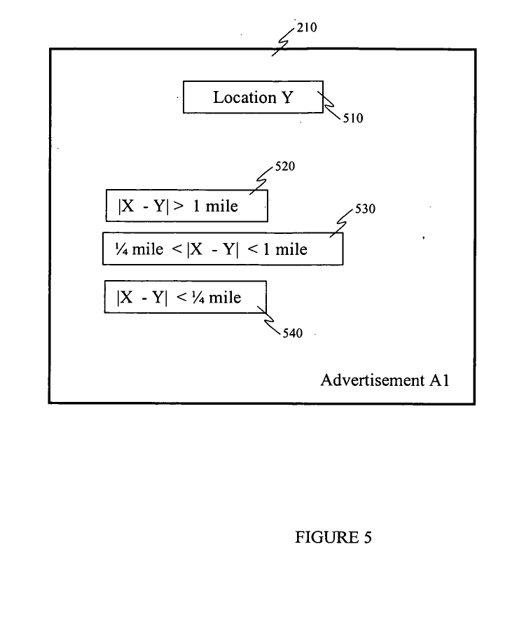

More specifically, the invention allows the advertiser to create an advertisement that has differing bid values based on the distance of the mobile handset compared to a location specified by the advertiser. FIG. 5 is a screenshot that shows details of specifying location for an advertiser's placement bidding using the placement bidding system of the present invention. The location of the user, that is, the computing device 130 that the user is using, is represented by X. As shown in FIG. 3, all advertisements can include a location criterion 330. The location can be specified by providing a street address, a geographic coordinate for latitude/longitude, or other means. In FIG. 5, the detail information for the location criterion of the Advertisement A1 210 shows that the advertiser input location is represented by Y 510.

Once an advertiser provides a desired location Y for an advertisement, the advertiser can vary the maximum price to be paid for placement of the advertisement based on the distance between the user location (X) and the advertiser input location (Y). An exemplary bid entry screenshot for advertisers to enter bid amounts is described below in connection with FIG. 8. The distances for the location criterion 330 can be automatically set by the advertising system 100 or can be arbitrarily set by the advertiser. FIG. 5 shows three such distances. The first distance specification 520 shows the bid is for placement to a computing device that is more than I mile from location Y. The second distance specification 530 is a bid for placement to a computing device that is between ¼ and 1 mile of location Y. The last distance specification 540 is a bid for placement to a computing device that is less than ¼ mile from location Y. Other distance specifications can be set, with corresponding bid amounts provided by advertisers.

As described herein, this technique for receiving advertiser bidding for ad placement is useful for many advertisers. One use is for merchants with a single storefront whose customer base is within a few miles of the store. For example, a dry cleaner establishment is likely willing to bid more for a potential customer who is less than 1 mile from the store and who has submitted a search with a keyword related to laundry or cleaning, as opposed to bidding for a potential customer who is searching for laundry or cleaning but is currently across town or in another city. Thus, the system can generate additional interest from advertisers who would not be interested in bidding for ad placement that is based on keyword alone, and the system can provide more relevant results for users who are searching.

User Features—Profile

Lastly, FIG. 3 shows that another criterion is that of user profile 340. Generally, the profile criterion 340 requires the ability to associate a particular person with the particular computing device that is being used to submit a search query. The user profile criterion can allow for a user to specify (self-report) user profile data. Thus, a user might register for search services (and consent to targeted advertising) and as part of that registration process the user could supply identification as being a member of a national organization, or being in agreement with a range of causes, or having certain personal characteristics. Alternatively, the system 100 could obtain personal profile data through data mining techniques, such as by checking browser “cookies” or reviewing user Web browsing history, or the like. Other automatic identification features can be used to discern a user as a unique individual and to maintain a profile for that user.

Profile-based advertisement placement bidding is especially convenient in the case of mobile users. Mobile computing devices, such as telephone handsets and PDAs, are not often shared between friends or family members and thus are generally highly specific to an individual. A search that is submitted through a mobile device is likely submitted by the same individual who is registered to the device through a network access provider. In contrast, fixed location devices (such as desktop Personal Computers) are often shared among multiple persons and individual identification is more problematic. That is, the system cannot necessarily discern when a fixed-location device user might be using login and registration information of another user. If that occurs, then the user profile associated with the user login might not correspond to the profile of the actual user of the computing device. In addition, every mobile handset has a unique identifier, which is often shared with data service providers. Such features make individual identification of users an easier proposition for the mobile user. These factors allow mobile advertisers to better target advertisements to individuals.

In any case, in the present system 100, mobile advertisements, as well as advertisements on the Web, can be targeted to a user device by customer profile, in accordance with reasonable assurance of individual identification. An advertisement can contain no profile, one profile, or an arbitrary number of profiles. As with the other target criteria, the advertiser can enter bids for profiles of interest. A winning bid will match a search query to the advertiser's bidding criteria and will result in delivery of the advertiser's selected content to the user who submitted the matching search query. An exemplary bid entry screenshot for advertisers to enter bid amounts is described below in connection with FIG. 8.

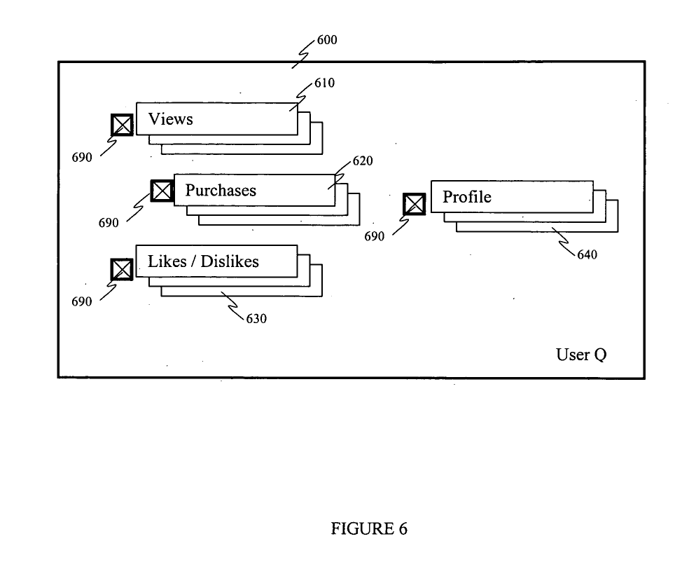

FIG. 6 shows an example of a profile database entry 600 for a single user of the system, who is identified as User Q. The profile data can include: the pages 610 viewed by the user; the items purchased 620 by the user; and an analytically generated list 630 of the topics liked and disliked by the user. The user profile data can be viewed and edited, if desired, by clicking on a category 695. To avoid erroneous or inaccurate data, the data items should be generated automatically by data mining or gathering techniques. Profile data that is compiled from self-reporting techniques might not be as accurate as automatically generated profile data. Those skilled in the art will understand the variety of techniques suitable for user profile data gathering. The named profiles 640 (defined below) in which the user belongs are noted in the user profile entry. These stored profile values are used by the advertising placement system to ensure that advertisements targeted to specific profiles are placed for users with matching profiles.

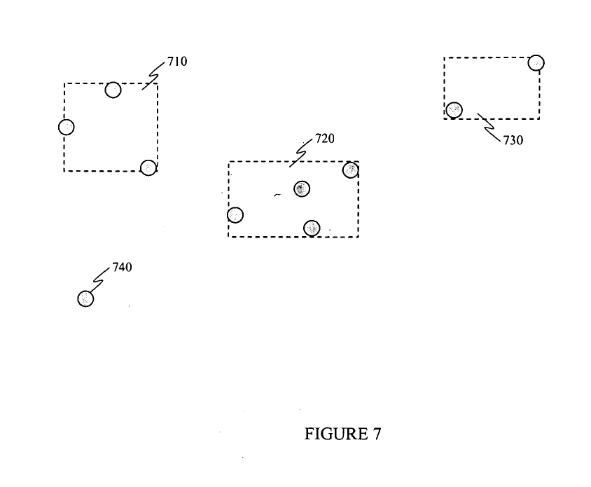

After user profile data values have been collected per FIG. 6, commonly understood data mining techniques are utilized to “cluster” similar users into named profiles. FIG. 7 shows a very simple, two dimensional diagram of such clustering. The circles represent customer profile database entries like those entries 600 illustrated in FIG. 6. The FIG. 7 boxes 710, 720, and 730 represent clusters of similar users. A user 740 shown not grouped with other users is an “outlier” that does not fall into any of the user profile clusters and thus cannot be targeted by means of a named profile. That user 740, however, is likely capable of being targeted by means of the other criteria described herein.

Entering an Advertisement Placement Bid

FIG. 8 shows a user interface screenshot 800 of the display window for entering an advertisement bid and targeting the bid in the system of FIG. 1. The display 800 shows that advertisers can enter bids for placement of advertisements by several targeting criteria, comprising keyword 820 and one or more of the other criteria including concepts 830, location 840, and profile 850.

The maximum bid for an advertisement placement is entered in an input box 810 of the system display. The targeting for the ad placement is specified using a plurality of window check boxes 890. In this way, an advertiser can specify any combination of keywords, concepts, location, and profile. The check boxes 890 marked by the advertiser during bid entry will specify which of these targeting criteria to use. For each criteria checked by an advertiser, a new window will appear as appropriate for additional data entry by the advertiser in specifying parameters of the selected target criterion.

As noted above, the system can have an arbitrary number of named profiles, each corresponding to a multi-dimensional computation data set similar to the illustrative profile boxes seen as 710, 720, and 720 in FIG. 7. Such named profiles can consist of simple profiles such as “Male” and “Female”, or can comprise more complicated groupings such as “Music Lover”, “News Hound”, or “Power User”. The profiles to be supported can be selected by the entity implementing the system 100. An advertisement can be targeted to one or more of the named profiles 850, as well as one or more of any of the other targeting criteria 820, 830, 840. The advertiser bid consists of the selected target criteria combined by a logical AND operator. That is, all of the specified targets must be satisfied for the advertiser's bid to match a user search query and for an advertisement to be placed. The advertiser bid is submitted with selection of the “ENTER” display button 895.

In the advertisement bid system 100, it is possible to submit bids on multiple parameters even within a single targeting criterion. FIG. 5, for example, shows multiple bidding parameters for the targeting criterion of location. Similarly, it is possible to specify parameters for other criteria, such as profile and concept. As with FIG. 5, the multiple parameter selection begins with selection of a single one of the targeting criteria (i.e., selecting one of the boxes 310, 320, 330, 340 in FIG. 3) such that a multiple-box or drop-down menu is displayed similar to that shown in FIG. 5. The multiple boxes in FIG. 5 shown in shadow behind each foreground box are meant to indicate multiple parameters sets possible with each targeting criteria.

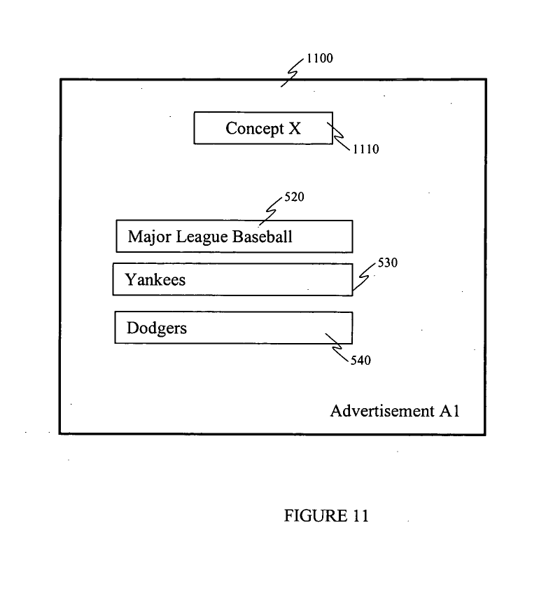

FIG. 11 shows a screenshot for selection of concept targeting criteria relating to “sports” and shows the means by which a concept can be selected by an advertiser using the advertisement bid placement system in accordance with the present invention.

As noted above, once the concept hierarchy is generated and the user profiles are set up, the keywords used to find the pages are no longer of great importance for bidding on advertisement placement. Instead, an advertiser can choose the appropriate combination of keywords and also one or more concepts, locations, and profiles that best describe the advertiser's target audience. Thus, if an advertiser wants to bid on placing advertisements in connection with searches on any baseball-related pages, the single concept of “baseball” or profile of “baseball fan” is the only target criteria required for successful ad placement. In a keyword bidding system, the keyword “baseball” would be required, as would the name of every baseball team, plus every name of every player on every team, plus every player in the Baseball Hall of Fame, and so forth The system 100 provides a much simpler interface and much simpler procedure for getting superior results from search processing and ad placement bidding.

As noted previously targeting by any one of the criteria is not mutually exclusive to targeting by any of the other criteria. All targeting is achieved by receiving an advertiser's bid specification that includes at least one criterion other than keyword. In this way, relatively sophisticated ad placement bidding is possible. For example, an advertiser can place bids to target an advertisement directed to the concept of “baseball” if the search query includes the keyword “bat” and if one other characteristic (e.g., user profile, additional keyword in the search query) indicates that the user is likely seeking information about a baseball bat and not the flying animal. This aids in discriminating between baseball bat searches and flying animal bat searches.

Thus, operation of the system 100 in response to receiving a user search query from a user computing device may be summarized by the following pseudo-code that describes the sequence of operation carried out by the system:
receiving a user search query that is directed to a collection of pages;
identifying one or more result pages from the collection of pages that satisfy the search query;
comparing keywords of the search query and a concept hierarchy of the result pages and user features against a set of bids for keywords, concepts, and user features submitted by advertisers to identify matching bids;
selecting a winning bid from among the matching bids.

These basic data processing operations described in the pseudo-code above can be further specified, as noted above. For example, the concept hierarchy can take many forms and can include many levels or sub-concepts. Also, the user features can include automatic and self-reported characteristics, such as user profile and also user geographic location. In addition, the set of bids received from advertisers can include logical combinations of the keywords, concepts, and user features (profile and location data). The system also provides a convenient user interface with which advertisers can enter their bids and set their preferred combinations of criteria.

System Description

The system described herein can be implemented in a mobile device advertising platform that provides an advertising solution for the mobile device market space that is performance based and that provides the user with an enriched browser experience. Such a platform has been developed by the assignee of the present application, Medio Systems Inc. of Seattle, Washington, USA. References to “Medio Systems” or “Medio” shall be understood to refer to the Medio Systems, Inc. mobile device advertising platform. The Medio Systems mobile device advertising platform includes components directed to reporting and analytics, with which advertising performance and effectiveness can be determined.

1.0 Medio Systems Platform and the Market

As noted above, advertising on mobile handsets is a nascent market, but a highly discussed topic in the industry. It is expected that a number of mobile advertising platforms will be launched in 2006. However, based on online advertising trends since the mid-1990s, the methods that the advertising community will ultimately adopt and mobile subscribers will accept will likely not shake out until 2008 or 2009.

These market conditions are analogous to the Web in the mid-1990s. Yahoo, Lycos, and AltaVista originally sold impression-based banner ads of various sizes and placement on their search engines, CNN, C|Net, and others did the same on their content websites; and later resellers like DoubleClick and LinkExchange acted as wholesalers for a variety of smaller sites. Later on came paid-placement (Go2.com, later known as Overture) and click-through ads, and then Google introduced the wildly popular self-service model for advertisers using three-line ads in AdWords, and contextually relevant text ads in AdSense.

The business model of Medio Systems is based on development of a performance-based mobile advertising platform and associated revenue model, and bringing this model to market in co-operation with wireless carriers.

2.0 Mobile Centric Advertisements

Mobile advertisements are vastly different from PC-based Web advertisements due to seven primary factors:
No universal browser
Screen size
Keypad input
Network issues
CPU
Memory
Network cost

Combined, these factors have a dramatic effect on the customer experience. The Medio System Advertising Platform, as part of the Medio Systems Search System, makes the most of the mobile environment to provide best-of-class search and advertising.

2.1 Browser

Mobile handsets do not feature a universal browser comparable to the PC's Internet Explorer or Firefox. Instead, a mobile handset may use one of dozens of different browsers, in different versions, each of which uses a different subset of WML, XHTML, and Cascading Style Sheets. This fact means that mobile browser content must follow the same write-once, test-everywhere methodology required by custom-developed applications such as J2ME and BREW.

2.2 Screen Size

While the average PC monitor currently averages about fifteen inches diagonally, most mobile handsets' screens measure between 2 and 2½ inches. Handset screen resolution is typically between 120×120 and 172×220 pixels. While the newest popular handsets provide 240×320 resolution, the actual physical size of the screens remains near 2 inches. This fact limits the amount of information that can be presented on a single screen. Normally a single advertisement, or at most three one-line paid-placements, will fit on a mobile screen without severely impacting the overall customer experience. These screen sizes restrict the presentation of information to one long, scrollable column, because there simply is not space for a left-column navigation pane nor a right column filled with advertisements.

2.3 Keypad Input

The desktop or laptop PC uses a mouse or trackpad and a full QWERTY keyboard for input and navigation. Mobile handsets have standardized on a 12-key numeric telephone keypad, a 5-way navigation control, and 2 softkey buttons. Some phones also include a dedicated “back” or “clear” button, others a third softkey, and many provide a second up/down toggle for adjusting volume. These auxiliary buttons simplify the most common actions, but do not change the customer experience as a QWERTY keyboard would. This restricts the potential navigation options within a single displayed page. Selecting an item at the bottom of a page, for example, is an order of magnitude more cumbersome on a mobile phone than on a PC browser, requiring up to 20 key presses vs. one click of a mouse. Similarly, viewing a piece of information “below the fold” is much more difficult on a mobile screen than pressing Page Down or using a scroll bar on a PC. Scrolling a page to the bottom can require dozens of key presses and can cause frustrated customers to stop using their handset for data services.

2.4 Network Issues

Typical wireless networks include relatively large latencies and relatively low throughput. Even EVDO and UTMS networks include latencies which feel like a long wait to a customer who is accustomed to a broadband PC connection. Research has shown that the more portable a device, the lower all latencies must be to feel like a quick response. On a PC, an-application that starts within 5 seconds provides an acceptable experience. On a notebook, returning from standby can take up to 10 seconds before causing frustration. However, on a handheld device, any delay of greater than 100 milliseconds is noticeable. Handsets are panned in reviews if pressing a button does not bring an “immediate” response.

In the near term, wireless networks are not likely to gain enough speed to feel quick and responsive. Despite the promised speeds of 3G networks, the average delivered speeds are still slower and more jitter-prone than the broadband connection that customers are used to at work and at home.

2.5 CPU

Over the past few years, CPU speeds on mobile handsets have improved dramatically in all benchmarks. However, much of that CPU improvement is consumed in powering wireless networks with higher data speeds, driving larger displays, and in driving enhanced user interfaces. The residual CPU capacity continues to increase, but still lags far behind the CPU speeds found on even the cheapest of PCs.

This difference affects a device's apparent speed in scrolling a page, animation frame rates, and ability to simultaneously stream data while the customer interacts with an application. Along with the network capacity, CPU power limits the number of images that can appear on a single page, and more fundamentally, limits the complexity of applications built on mobile handsets.

2.6 Memory

While amount of RAM available on mobile handsets has increased dramatically over the past few years, it is typically still measured in single-digit megabytes, while a typical PC boasts at least a half of a gigabyte. Handsets' flash memory storage has also increased, but still pales compared with the storage on a PC. Few mainstream handsets today have slots for removable memory cards. Disk drives are now found on a handful of mobile handsets, but are unlikely to appear on mainstream devices for a few years, due to price, size, and dramatic effect on battery life.

A handset's relatively small amount of memory affects the “slickness” of any mobile advertising, especially when combined with the small amount of data which can realistically be downloaded within one second across a wireless network. The result typically limits animations to one or two frames per second, vs. 20 frames per second on a PC. The almost complete lack of persistent memory further reduces the “slickness” of mobile advertising. The cache on a handset is severely restricted, thus few advertisements can be cached. This results in less relevancy for cacheable ads, and reloading ads increases network usage.

2.7 Network Cost

While many consumers pay a fixed monthly fee for PC and wireless bandwidth, the actual cost of delivering one kilobyte of data over a wireless network far exceeds the cost on the wired Web.

This is often the primary limitation to providing the best possible customer experience. Within the next three years, wireless' capabilities will increase dramatically:
Typical screen resolutions up to 320×480;
5-way navigation controls replaced by an analog joystick of similar size;
4G networks with lower latencies and higher throughput;
CPUs at least twice as fast as today;
RAM capacity for tens of seconds of animation frames;
Flash memory capacity for hours of video.

Despite all of these improvements, unless the cost per kilobyte of bandwidth drops dramatically, wireless carriers will be forced to limit the amount of data per page, and thus limit the customer experience. This is a hot topic today. While a text-only page might use only three-quarters of a kilobyte, a page with one small image can often be 4K of data or more. The bandwidth cost difference, over millions of pages and millions of subscribers, is significant.

3.0 Medio Systems Advertising Platform

3.1 Overview

Medio's solution will provide a mobile-centric, performance-based advertising system, complete with a web-based application for bidding on ad placement based on keywords, concepts, location, and customer profile. Advertising types will include text ads, banner ads, interstitial ads, paid placements, and pay-per-call.

This Advertising Platform includes three major components:
Web-based Advertising Management, Reporting & Analytics Toolkits
A web-based Advertiser Bidding System
An Advertisement Placement Engine/Optimizer

3.2 Advertising Management, Reporting & Analytics Toolkits

The web-based Advertising Management Toolkit provides monitoring of search traffic and advertisement placement for Medio's wireless carrier partners.

In addition, this console includes an interface for “digging down” into the performance of any advertisement using analytics, generating reports, and exporting data into other analysis tools.

3.3 Advertiser Bidding System

Today, a blue hyperlinked ad title followed by two lines of text is sufficient for the experience on the PC-based web. However, mobile demands more creative, intuitive, and functional advertisements. For instance, how would users experience today's web ad inventory when most HTML sites are not viewable from a mainstream mobile device?

Medio's Bidding System will necessarily be both more feature-rich and complex than Google's AdWords (above), but will include similar functionality, providing a self-service set of tools for advertisers large and small.

3.4 Advertisement Placement Engine/Optimizer

The key Advertising Platform component, and by far the most complex, is the Advertisement Placement Engine; This component uses the rules and bids from the Bidding System to optimize the best advertisement for every search and information page delivered by Medio's servers.

Generally, the Advertisement Placement Engine uses this formula:
CTR*CPC*P(A)
Where CTR=Click Through Rate, CPC=Cost Per Click or Cost Per Thousand, and P(A) is a Predictive Analytic measure of whether a particular advertisement to be likely to be clicked, based on the search keywords and the subscriber's search and click-through history. This is one of the unique, patent-pending technologies that Medio has developed for mobile advertising that produces significantly increased revenue.

4.0 Types of Advertisements

Medio's Advertising Platform initially features four forms of advertisements:
Banner Ads
Interstitial Ads
Paid Placement
Pay-per-Call

Over time, subscribers and advertisers will eventually agree upon the most acceptable and effective forms of advertising, and Medio expects to add other forms as the market matures.

4.1 Banner Ads

Screen “real estate” is a much more precious commodity on mobile handsets than on the PC-based web. Whereas on a 15-inch monitor a 600×80-pixel banner is unobtrusive, that one image contains more pixels than entire screen on most popular handsets. Similarly, three or four banner advertisements, in a 200-pixel-wide column along the right side of a web page, are considered unobtrusive. In the mobile world, two columns are feasible only on the largest of smart phones.

Banner ads in Medio's Advertisement Platform can consist of text, images, or animations, depending on the markup language, the capabilities of the handset, and the advertiser's creative choice. Unlike Google's three-line text ads or PC-based banner ads, all of the above variants must be provided by the advertiser. Banner ads can be purchased on an impression or performance (click-through) basis.

4.2 Interstitial Ads

Network latency on wireless networks is a minimum of two seconds, and typically four to six seconds, while initial network access can take as long as 20 seconds. Many complex PC-based web pages (such as a GMail inbox) can take a similar amount of time to load. However, the expected latency on handheld devices is much lower than on a PC, making even two seconds feel like a long time to wait. This latency is an opportunity to present the most unobtrusive of advertisements, namely interstitial ads. Like banners, interstitials can use text, images, or animations. As with banners, the advertiser must provide variants for a range of handset capabilities.

To compensate for latency, an initial set of interstitial ads must be resident on the client, and the at least part of the Advertisement Placement Engine must also be resident on the handset. This enables the interstitial ad to essentially fill the time that the network and client require to display the next page. After the page is downloaded, the search system updates its cache of interstitial ads, adding those most relevant to the keywords or page. Interstitials are likely to be impression-based to start, but click-throughs can be performed and measured on an interstitial ad as well.

4.3 Paid Placement

Paid placement search results are an acceptable form of advertisement on the PC-based web. Similar paid placements will be possible in Mobile Search, although screen dimensions limit the number of paid placements that can be displayed prior to any algorithmic search results. Paid placement results can include yellow page listings, “featured” merchandise, or cross-promotions. Paid placements are always performance-based.

4.4 Pay-Per-Call

The pay-per-call model is fairly new on the PC-based web. Implementation of this model generally includes VoIP clients and/or special toll-free phone numbers that must be carefully tracked. This adds to the complexity of this model, and for this and other reasons, click-through ads which lead to a web site are much more popular than pay-per-call.

On mobile, the most intuitive action is to speak on the phone. Medio expects that a very common action upon selecting an advertisement is to dial a phone number. This also takes advantage of a significant limitation: most advertisers will not have a mobile-displayable website, and many may not have any website.

The pay-per-call model is ideal for local merchants. These businesses pay large sums of money to advertise in the Yellow Pages and in local newspapers. They understand the value of a customer calling their phone. These calls are valued in dollars, not pennies, and thus represent a significant, untapped opportunity.

Pay-per-call also works for national advertising campaigns. It is the flipside of telemarketing, enabling interested customers to call in instead of hiring vast pools of callers to make intrusive cold calls. It is far easier to close a sale over the phone than via a web site. Pay-per-call is always performance-based.

5.0 Types of Bidding

Medio's Advertising Platform includes an auction model for advertisement placement, allowing advertisers to bid on multiple placement types:
Keyword
Concept
Profile
Location

This goes beyond the simple keyword-based placement typically seen on the web. The follow subsections explain each of these placement types.

5.1 Keyword

This is the method commonly found on web search engines. An advertiser specifies a keyword, set of keywords or exact phrases, and the advertisements are displayed on search results related to those keywords, or on pages contextually related to those keywords.

5.2 Concept

Medio's Search System incorporates much more insight into the actual concept being searched. For example, when a subscriber searches for “Usher”, the search results are grouped by concept, such as Ringtones, Wallpaper, Games, News, and more. Advertisers can place bids based on any of these concepts. Each of these concepts is composed of sub-concepts. For example, Ringtones may include Hip-Hop Ringtones or Truetone Ringtones.

Bidding for concept avoids the difficulties inherent in bidding for keywords, wherein an advertiser must research a set of keywords which match the target concept. It allows, for example, the automaker Jaguar to bid on the concept of “Automobiles” and avoid placement with results featuring jaguar cats.

5.3 Profile

Medio's Search System is fully personalized, analyzing the full search history of each customer and grouping customers into common profiles. For example, customers who generally search for ringtones can be organized into a “Ringer Buyers” profile, and customers who often read their horoscope can be organized into an “Astrology” profile. With the carrier's assistance, profiles for age, gender, and home town are also possible.

Profiles allow advertisers to target audiences, no matter what those customers happen to search in any day. In addition, profiles can be added to the other placement types to limit advertising placement to specific profiles, even in keyword-generated results.

5.4 Location

Medio's Search System is location-aware. Location may consist of little more than the last or most-frequently specified city for a weather forecast, or it can become as specific as the current cell tower identifier, or a GPS-derived location accurate to within a few meters. This provides local advertisers with the ability to participate in the mobile advertising market.

As mobile devices incorporate location technology, all carriers will eventually provide highly accurate location data, allowing for location-sensitive advertisements. For example, the nearest Starbucks can provide a special offer to subscribers who are within two blocks of the store, and different offers for subscribers more than one mile away.

Like profiles, location can be added to the other bidding systems to better target customers who are searching for specific types of content. This should greatly increase the relevancy, and thus the action-rate, of advertisements, resulting in higher average bids.

6.0 Advertisement Relevancy

A search engine with an integrated advertising platform has proven to be a key combination for delivering relevant advertisements that achieve results for advertisers. The same should hold true for mobile.

There are two methods for achieving relevancy. First, the keywords used in search queries help explicitly match a customer's intent with an advertisement. Second, when viewing news articles and other information sources, it is possible to perform an implicit, contextual search based on the contents of the page.

6.1 Explicit Search

Medio's Search System uses text-based search queries. A query is mapped to keywords and concepts culled from various searchable information sources, providing results relevant to the customer. Similarly, these keywords and concepts, combined with the location and profile of the customer, are used by the Medio Advertising Platform to match the most relevant advertisement to the search results.

For example, Callaway Golf can bid for the concept of “golf.” If a customer searches for a golf celebrity, such as “tiger woods” or “annika sorenstam”, or golf tournaments, such as “US Open” or “Masters”, the search will automatically be associated with the concept of “golf” and the customer will receive search results including games, wallpaper, and news stories of the respective golf celebrity or tournament, along with the Callaway advertisement. Thanks to Medio's unique concept-based targeting, Callaway does not need to list all possible keyword combinations to appear in all golf-related results.

In another example, Nike can bid for the concept of “basketball,” and for the profile of “Urban Music Listeners”. If a customer who previously purchased a 50 Cent ringtone later searches for “raptors”, the Nike ad appears, along with the latest Raptors information, such as game score.

6.2 Contextual Search

In addition to a text search box, Medio's Search System includes multiple forms of contextual search, such as the links presented in search results.

For example, a customer who searches for “pacman” finds a downloadable Pac-Man game. That page will also include recommendations for other games such as Asteroids. If the customer follows the Asteroids link, Medio's Search System knows that the page falls under the concept of “games” and that Asteroids is a “retro” game. Electronic Arts could bid for an ad under those concepts, or simply using the keyword “asteroids,” to have its ad presented on that page, even though the customer never actually typed in that text.

Similarly, a customer searches for “cnn” and receives a list of top news stories from CNN. Following one link, he reads a news story. Medio's Search System will extract the keywords and concepts described in that news story, and present a relevant advertisement. Again, the customer did not type a specific keyword, but a relevant advertisement appears.

Addendum A. Medio Systems Advertising Platform

The Medio Systems Advertising Platform is a customized solution, provided by Medio Systems, that is tailored for Medio Systems customers, such as particular service providers.

A.1 The Goal

The goal of the Medio Systems Advertising Platform is to increase customer revenues by selling ad placements of various types across all the possible data services. This goal has been reached today on the PC-based Web, and Medio believes it should carry over to mobile handsets.

This document describes mobile banner, interstitial, paid-placement, and pay-per-call advertisements. These can be integrated into the existing WAP browsing experience, the WAP search experience, the “rich” search application, ultimately deep within the pages of the content providers' pages, and perhaps even into the downloadable games and videos.

A.2 Eyeballs First

It is generally not accepted practice in the industry to have advertisers ready to buy ad placements without sufficient related “eyeballs” to view those ads. Those eyeballs need to belong to recurring customers, and the initial experiences of those customers can not be compromised by an abundance of ads or the constant repetition of identical ads; the proper balance of advertisers and search inventory is necessary to maintain a healthy performance-based advertising ecosystem.

From today's web-based systems we know the advertising dollars of the first few tens of millions browsed pages and search results are of little value compared to more quickly building a search-based experience which leads toward hundreds of millions of searches per month. It is only this greater scale of searches, targeted accurately to the customers' interests, that will lead to large numbers of advertisers and hence will lead to competitive bids all of which together will add substantial amounts of revenue.

A.3 Example Metrics

Advertising is all about the numbers. No matter the style of ad (i.e. banner, pay-per-call, etc.), advertisers demand large numbers of potential customers in order to justify placing an ad. Take the following example:
Advertiser A is willing to spend $0.10 per “click-through” to find 1000 customers.
A typical click-through rate for a successful ad is 1%.
Suppose on average 100,000 unique customers viewing 10 pages per day.
100,000 customers×5 pages/day=500,000 page views/day
500,000 page views×1%=5,000 click-throughs
5,000 click-throughs×$0.10=$500/day

This example assumes every page view includes the advertisement. It in fact assumes every page view includes the same advertisement. Both of those assumptions are flawed. More reasonably, about 50% of the page views will have both a reasonable location to place an ad, and a relevant advertisement to be placed. Plus more reasonably, there will be thousands of advertisers, within only 50% of the advertisements having a successful click-through rate. These two additional factors drive down the expected revenue to as low as $125/day. At that rate, it's simply not worth the effort to deploy advertising, comparatively speaking.

The other assumption hiding in this example is that 500,000 page views have estimated worth of $500/day. If these 500,000 page views are split amongst 1,000 advertisers, then on average there are only 5,000-page views per advertiser per day. At a 1% click-through rate, that is only 50 click-throughs per day. For any large advertiser, that is not worth the effort to manage an advertising campaign.

A.4 Getting the Experience Right

Browsing via a WAP deck is a sub-optimal customer experience. Adding advertisements to that experience is not an improvement. Search, on the other hand, is expected to be a positive and effective customer experience. Adding advertisements to that experience before it is perfected will potentially jeopardize the entire mobile advertising business.

Returning to the previous example, but moving forward to many months from now when search is a common daily use on a mobile handset:
1,000,000 customers×2 searches/day=2,000,000 searches/day
5 page views/search*2,000,000 searches/day=10,000,000 page views/day
10,000,000 page views×1%=100,000 click-throughs
100,000 click-throughs×$0.1=$10,000/day

This model does not suffer the same flawed assumptions as the previous model. These ad placements are based on explicit and contextual search, and thus each ad is as relevant as possible from the inventory.

The keys to this model are in increasing the average number of searches per customer per day and increasing the average number of page views per search. The former is maximized by providing a great customer experience across a wide number of search categories. The latter is increases by making that experience as “sticky” as possible to ensure more opportunities to present advertisements.

However, generally customers do not want to view advertisements, especially if they are “in the way” of the desired information or in any way slow down the experience. Thus, until mobile search is an ingrained habit, any use of advertising that degrades the customer experience may prevent that habit from forming, lower the number of customers using search, lower the average number of searches per day, and lower the average number of pages per search. Lowering any of those factors ultimately lessens the revenue opportunity from advertising.

A.5 Relevancy

Placing advertisements is a tightly coupled technology to search. They both have identical goals of displaying the most relevant information to the customer. Both use the search keywords (explicit or implied) from the page. Both can be improved using personalization. Both can be improved using analytic recommendations. For this reason, it makes sense to combine an advertising platform with a search engine. That has been proven multiple times on the PC-based Web. Google and Yahoo far exceed the advertisement placements and revenues of the next nearest competitors.

Relevancy also plays an important role in growing the advertising base. Via the search logs, it is possible to determine that X% of the customer base is searching for topic T. That information can be used to target vendors serving topic T. The actual metrics of number of searches, number of unique customers, etc. can be used to excite those vendors sufficiently to sign up with the service provider as advertisers. This targeted sales process avoids having large numbers of advertisers targeting unpopular topics, which would lead toward large numbers of unhappy advertisers. This is part of the virtuous cycle of search+advertising.

A.6 Conclusion

Medio Systems brings critically important Thought Leadership, Mobile Centric advertising approaches, Search expertise, new Advertiser Bidding Options, and wide-scale production experience to produce the world's leading mobile search and advertising services for mobile carriers.

Medio Systems Architecture

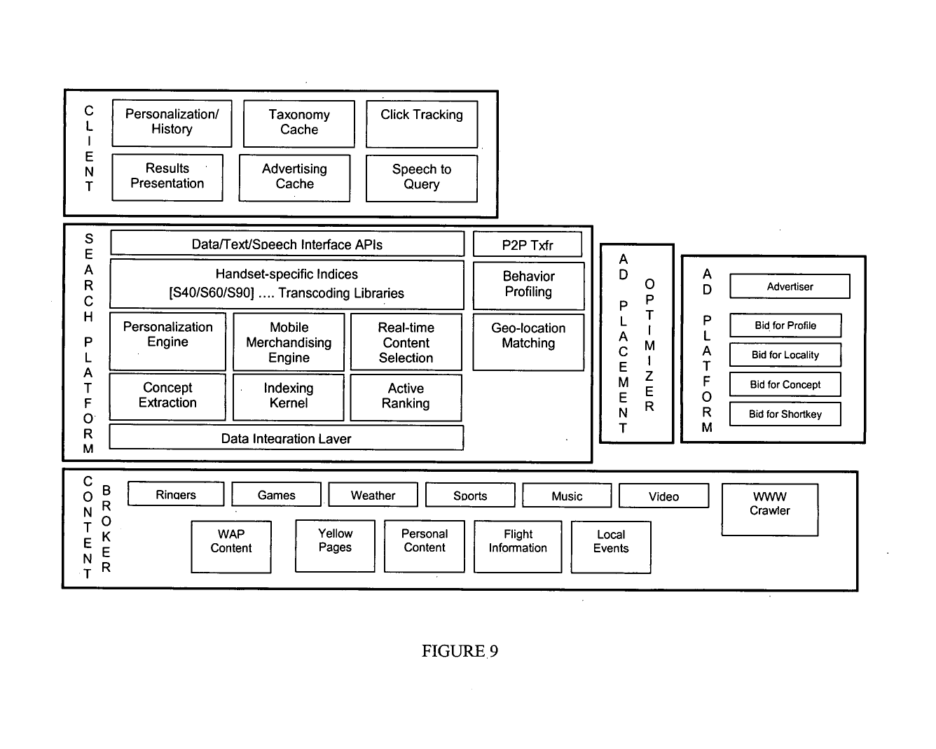

The exemplary embodiments described above in conjunction with the drawings of FIG. 1 through FIG. 8 can be implemented in an architecture that utilizes software installed client-side on the mobile devices and also installed server-side for performing the search function, supporting ad placement bidding, and for providing access to content. An example of one such implementation is illustrated in the architecture diagram of FIG. 9, in which the mobile device installed software is represented by the “Client” depiction, the search engine software is represented by the “Search Platform” depiction, the ad placement bidding software is represented by the “Advertising Platform” and “Ad Placement Optimizer” depiction, and the content access software is represented by the “Content Broker” depiction.

Thus, in the exemplary embodiment of FIG. 9, the client software includes procedures or modules to provide a personalization history with user preferences, a taxonomy cache, click tracking for the user, results presentation for rendering pages, an advertising cache for received advertiser pages, and a speech-to-query module, if desired.

Also in FIG. 9, the Search Platform is illustrated as having a variety of modules and functions. It should be understood that modules providing features and functions in addition to those necessary for the operation as described in accordance with the invention are optional. For example, device position location determination is not necessary to all embodiments described above, and therefore the “Geo-Location Matching” module depicted in FIG. 9 is optional.

In the CLIENT component:
a. The Personalization/History component stores the recent searches performed by the subscriber. This is used to tune the search experience within the handset without requiring an interaction with the server.
b. The Taxonomy Cache component stores the popular keywords, concepts, and categories. This is used by the Personalization/History component to further tune the search experience.
c. The Click Tracking component stores all the key presses and other forms of input with the handset-resident application. This information is periodically passed down to the server and used as part of the analytic feedback methods which provide personalized and generalized improvements to the overall search system.
d. The Results Presentation component renders the search results and other information on the handset.
e. The Advertising Cache component stores interstitial images and other advertisements for display on the handset without requiring an -interaction with the server.
f. The Speech to Query component performs all or part of the speech query. recognition.

In the SEARCH PLATFORM component:
a. The Data/Text/Speech Interface APIs allow external clients and services to perform searches using the SEARCH PLATFORM. This component additionally contains the APIs which interface the Medio client with the Medio search server.
b. The P2P Txfr component encodes search results as SMS, MMS, WAP Push, IM, Email, and other messaging formats allowing sharing of search results between subscribers.
c. The Handset-specific Indices component stores information cross referenced by handset model. This component includes libraries which can optimize the presentation of the search results for each handset model including transcoding of image sizes and transcoding of web markup and other file formats for viewing on mobile handsets.
d. The Behavior Profiling component performs data mining and other analytic methods whose results are used to improve the search results and to personalize the search results for individual subscribers.
e. The Personalization Engine uses the analysis from the Behavior Profiling component, the data from the Click Tracking component in the Client, and other data provided by the carrier to personalize the search results for individual subscribers.
f. The Mobile Merchandising Engine component uses data mining and other analytic methods to produce recommendations of content related to the content found in the search results.
g. The Real-time Content Selection component integrates external databases of content within the search results.
h. The Geo-location Matching component uses the location of the subscriber initiating the search to filter the set of search indices used to perform the search as well as filtering the search results in order to make them more relevant to the specific location.
i. The Concept Extraction component disambiguates the search query, extracting the likely meanings of ambiguous search terms and parsing queries containing syntactic properties.
j. The Indexing Kernel component contains the core search index libraries, the core search crawler libraries, and assorted other libraries which form the basis of the search engine's ability to search.
k. The Active Ranking component re-orders the search results based on analyzed global and personalized usage history.
l. The Data Integration Layer component ties together the data analysis information, the search indices, and other data warehouse information.

The AD PLACEMENT OPTIMIZER component interfaces with a multitude of advertising inventory databases, e.g. Advertiser Network and Medio's own inventory, and places the advertisement which maximizes the advertising revenue opportunity and the likelihood of the user to choose each specific advertisement (optimization).

The AD PLATFORM component integrates advertising inventory from a multitude of advertising networks, e.g. Advertiser Networks, plus it includes a performance based advertising bidding system with bidding based on customer profile, location, search concept, and search query shortkeys, as well as keywords.

The CONTENT BROKER component contains a set of highly tuned search engines plus the methods required to combine the results from all those search engines into a single page of results. The individual “searchlets” can be created for any type of digital content, including such examples as shown: ringtones, games, weather, sports scores, music downloads, video, web sites, WAP sites, Yellow Pages, content stored on subscribers' PCs, flight status, and local events.

The “Content Broker” block in FIG. 9 represents an application that manages access to, and download of, content from the network, such as the Internet or other content sources, including commercial sites where such content may be purchased. For example, such content may include Web sites that provide ringtones, games, weather, sports, music, and video. The Content Broker may utilize a Web crawler to obtain such information.

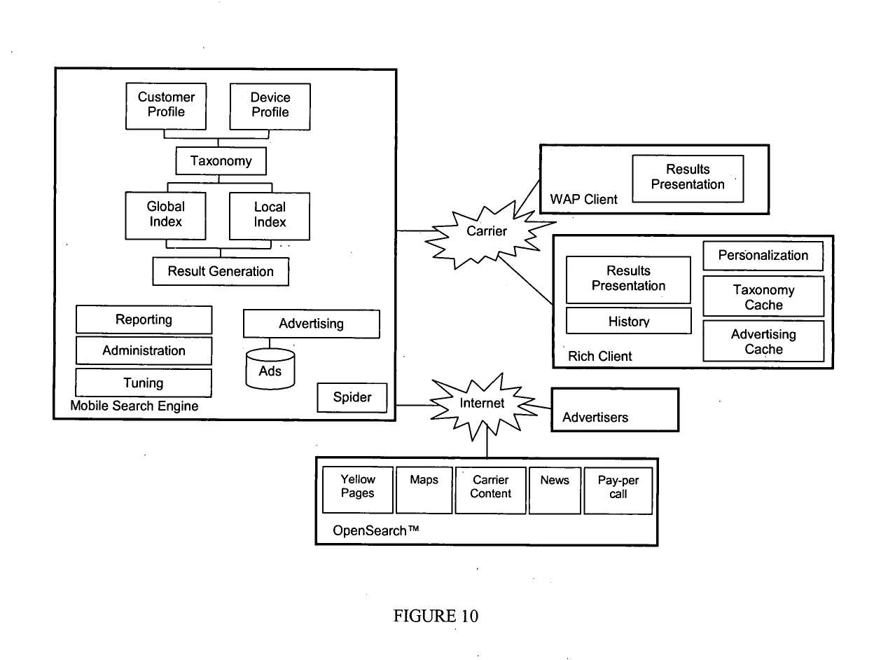

FIG. 10 illustrates an example of how the device clients, search engine, advertisers, and search facility (indicated as “OpenSearch” in FIG. 10) can be arranged in accordance with the invention. The device client, indicated in FIG. 10 as either a “Rich Client” or a “WAP client”, communicates with the device carrier, through which the client (user) gains access to network content and to the Search Engine. The Search Engine, in turn, gains access to advertisers and to the OpenSearch facility through Internet communications.

The Search Engine component in FIG. 10 contains the methods for generating a search result, for generating reports on the use of the search engine, an interface for administrating the search engine, an interface for tuning the search engine and ranking subsystem, an advertisement placement engine, and a spider/crawler subsystem for creating the search index. Search results are personalized based on a customer profile, filtered based on the device profile, and the search is performed across both the global index of accessible content in addition to a local index of content resident on the handset or resident on the subscriber's home PC or personal network storage locker.

The WAP Client component contains only a results presentation component.

The Rich Client component contains a results presentation component, plus components to locally cache advertising, history, and search taxonomy.

The Advertisers box represents the set of advertisers who access the advertising bidding component of the Search Engine via the Internet in order to place bids for advertisement placements.

The OpenSearch™ component allows external service providers to create Searchlets whose results can be integrated into the search results generated internally within the Search Engine.

As noted above, the operations described as being performed by the system in accordance with the invention can be performed by a computer processing apparatus. In accordance with well-known techniques, such operations on a computer processing apparatus can be implemented by means of installing processing software onto the computer processing apparatus. This is typically achieved by means of a program product containing appropriate program instructions (software). For example, the program product may comprise optical media such as a data CD or DVD that contains appropriate software to cause the computer apparatus to perform the described operations when the software is installed or may comprise other signal bearing media including a data signal. Likewise, any software to be installed on any of the computing devices described herein can be achieved with such program product devices to install the appropriate software onto the device for execution.

Having fully described several embodiments of the present invention, other equivalent or alternative methods of practicing the present invention will be apparent to those skilled in the art. These and other embodiments as well as alternatives and equivalents to the described system will be recognizable to those of skill in the art after reading the description herein. The scope of the invention should not, therefore, be determined solely by reference to the above description, but instead should be determined with reference to the appended claims along with their full scope of equivalents and alternatives.

We claim:

1. A computer method of processing a search query, the method comprising:
receiving a search query of a user that is directed to a collection of pages;
identifying one or more result pages from the collection of pages in response to the search query;
comparing keywords of the search query and a concept hierarchy of the result pages and user features against a set of bids for keywords, concepts, and user features submitted by advertisers to identify matching bids;
selecting a winning bid from among the matching bids.

2. A computer method as defined claim 1, wherein comparing user features against a set of bids include user features comprising automatic and self-reported user characteristics.

3. A computer method as defined in claim 2, wherein the user features include user profile.

4. A computer method as defined in claim 2, wherein the user features include user geographic location.

5. A computer method as defined in claim 1, wherein the set of bids submitted by advertisers includes logical combinations of the keywords, concepts, and user features.

6. A computer system that processes a search query, the system comprising:
a network interface for communicating with a network through which access to collections of pages is obtained;
a processor that receives the search query of a user for identifying one or more result pages in the collections that are responsive to the search query, compares keywords of the search query and a concept hierarchy of the result pages and user features against a set of bids for keywords, concepts, and user features submitted by advertisers to identify matching bids, and selects a winning bid from among the matching bids.

7. A computer system as defined claim 6, wherein the computer system compares user features against a set of bids include user features comprising automatic and self-reported user characteristics.

8. A computer system as defined in claim 7, wherein the user features include user profile.

9. A computer system as defined in claim 7, wherein the user features include user geographic location.

10. A computer system as defined in claim 6, wherein the set of bids submitted by advertisers includes logical combinations of the keywords, concepts, and user features.

11. A program product for use in a computer system that executes program steps recorded in a computer-readable media to perform a method for processing a search query, the program product comprising:
a recordable media;
a program of computer-readable instructions executable by the computer system to perform operations comprising:
receiving a search query of a user that is directed to a collection of pages;
identifying one or more result pages from the collection of pages in response to the search query;
comparing keywords of the search query and a concept hierarchy of the result pages and user features against a set of bids for keywords, concepts, and user features submitted by advertisers to identify matching bids;
selecting a winning bid from among the matching bids.

12. A program product as defined claim 11, wherein comparing user features against a set of bids include user features comprising automatic and self-reported user characteristics.

13. A program product as defined in claim 12, wherein the user features include user profile.

14. A program product as defined in claim 12, wherein the user features include user geographic location.

15. A program product as defined in claim 11, wherein the set of bids submitted by advertisers includes logical combinations of the keywords, concepts, and user features.
